(19) United States
(12) Patent Application Publication
(10) Pub. No.: US 2007/0056358 A1
(43) Pub. Date: Mar. 15, 2007

(54) Micro-rheometer

(76) Inventor: James ZT Liu, Hudson, NH (US)

Correspondence Address: Kris T. Fredrick;Honeywell International Inc., 101 Columbia Rd., P.O. Box 2245, Morristown, NJ, 07962, US

(21) Appl. No.: 11/225,142

(22) Filed: Sep. 12, 2005

(51) Int. Cl. G01N 11/16

(52) U.S. Cl. 73/54.41

(57) ABSTRACT

A rheometer apparatus includes an acoustic wave viscosity sensor associated with a flexural plate wave device configured to include a central cavity through which a fluid flows. A plurality of interdigital transducers cam be associated with the flexural plate wave device, wherein each interdigital transducer (IDT) thereof can measure viscosity associated with the fluid over a variable range of shear rates. The variable range of shear rates can be achieved by varying the flow rate of the fluid due to an adjustment of a vibrating amplitude associated with the flexural plate wave (FPW) device (e.g., an FPW pump).

### TECHNICAL FIELD

Embodiments are generally related to rheometers, and specifically, devices for the measurement of non-Newtonian and Newtonian viscosities.

### BACKGROUND

A rheometer is a device for measuring the intrinsic characteristics of a material. Known rheometers require fairly large quantities of a sample so as to obtain the required accuracy in analyzing the sample. Such large quantity samples, however, are usually not provided by drug discovery or combinatorial chemistry synthesizing methods in which a large amount of different samples of small quantity are produced.

Traditional rheological measurements taken on sample materials are performed in their simplest geometry such that the sample is placed between two parallel plates of a design area separated by a gap of known distance, wherein the sample is sheared by applying a force to one of the plates while keeping the other plate fixed. Such a configuration results in a deformation of the sample confined between the plates, which can be characterized in terms of the shear stress and the shear strain.

From these quantities and the dimensions of the sample, a shear modulus may be calculated. In general, the shear modulus is a function of the sample history, the shear strain and the strain rate. In measuring the mechanical property of a sample material, the sample is subjected to a varying force and the resulting deformation, i.e. the response of the sample is observed. The frequency response of the sample may then be analyzed in accordance with viscoelastic theories to obtain information on the required characteristic of the material.

A rheometer measures non-Newtonian and Newtonian viscosities. As utilized herein the term “viscosity” can be thought of as constituting kinetic viscosity, which is measured in centistokes, or dynamic and/or absolute viscosity, which is measured in centipoises. The values for centistokes and centipoises are typically related by the following formulation: centistokes=centipoises/specific gravity.

A third class of viscosity is often referred to as acoustic gravity and is based on units of centipoises x specific gravity (ρ). Knowledge of specific gravity (ρ) allows conversion between these three units at fixed shear rate and temperature. Whereas cups and capillaries measure kinetic viscosity (η/ρ), resonator viscometers measure “acoustic viscosity” (i.e., ρηω).

In general, rheology is the science of flow and deformation of materials. The viscosity of a material is related to its resistance to flow, while elasticity is related to its degree of structure. Rheometers thus can be utilized to measure both Newtonian and non-Newtonian fluids. A Newtonian fluid is one in which the viscosity does not depend on shear rate.

Regardless of the level of shear that is applied, the viscosity stays the same. In many applications, however, this is not the case and, as the fluid is sheared at greater rates, the viscosity will change. These types of liquids are known as non-Newtonian and there are many classifications. Many common solvents, mineral base oils, synthetic base fluids and fully formulated single-grade oils obey Newton's Viscosity Law. Non-Newtonian fluids are a mixture of pigments, suspenders, polymers, solvents, engine oil, silicone oil, and vegetable oil, etc. Each of these items by itself may or may not have Newtonian characteristics, but when combined they shear in unique, non-linear manners.

A typical conventional rheometer includes one or more bounding surfaces, one or more of which may be moveable by rotation or other means, between which a material whose viscosity or other visco-elastic property is to be measured is positioned. Movement of the moveable surface or surfaces may be controlled, for example by a microprocessor integrated with the rheometer apparatus. Typically associated with the rheometer are a force actuator for applying a known force to the sample via the one or more moveable surfaces and a position transducer which records displacement of a sample under test and hence the strain which it has undergone for a given applied force.

Two modes of operation are typically possible in rheometer devices. First, an open-loop mode can be provided, whereby the sample under test is subjected to a known force by the force transducer, secondly closed loop mode, where the sample under test is subjected to a controlled strain by regulation of the torque transducer. By suitable selection of a bearing suspension system (e.g., a low friction air bearing or a mechanical bearing with known frictional properties), the first mode of operation can be optimized and the rheometer is thus sometimes termed a controlled stress rheometer. In such a controlled stress rheometer, the force or stress is controllable with high accuracy so that the strain may be measured. The second mode of operation is sometimes termed controlled strain. In this mode, the force becomes the measured variable.

One of the problems with conventional rheometers is that such devices are limited in terms of their implementation and variability. That is, such devices are typically large and bulky, hence requiring large amounts of samples and can not easily be moved from location to location without expensive and time-consuming efforts. One other problem with such devices is that they are composed of many interacting components and parts, which also contributes to the overall cost of the device. What is needed to overcome these problems is a much more compact design, which is disclosed in greater detail herein.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for an improved detector device.

It is another aspect of the present invention to provide for a rheometer apparatus.

It is a further aspect of the present invention to provide for a micro-rheometer apparatus.

The aforementioned aspects of the invention and other objectives and advantages can now be achieved as described herein. A rheometer apparatus is disclosed, which includes a rheometer associated with a flexural plate wave device configured to include a central cavity through which a fluid flows. A plurality of interdigital transducers can be associated with the flexural plate wave device, wherein each interdigital transducer (IDT) thereof can measure viscosity associated with the fluid over a variable range of shear rates. The variable range of shear rates can be achieved by varying the flow rate of the fluid due to an adjustment of a vibrating amplitude associated with the flexural plate wave (FPW) device (e.g., an FPW pump).

The rheometer apparatus can be configured to further include the use of a shear rate measurement sensor connected to the flexural plate wave device, wherein the shear rate measurement sensor comprises at least on interdigital transducer for detecting acoustic wave viscosity data associated with a flow of the fluid through the central cavity of the flexural plate wave device. The cavity can be configured as a tube through which the fluid flows.

The rheometer apparatus disclosed herein functions based on the measurement of viscosity measured over a range of shear rate. Such a viscosity can be used as the basis for rheometry, which is more valuable than just viscosity. In such a design, the variable shear rates can be achieved by varying the flow rate via adjusting the FPW pump vibrating amplitude. While the viscosity is obtained through another acoustic wave viscosity detector. The overall rheometer apparatus configuration does not have moving parts. Instead, it functions as an acoustic wave actuator and sensor system.

In general, for a Newtonian liquid, the viscosity is independent of shear rate. The shear rate can be altered utilizing two possible techniques. One method involves changing the FPW device or pump flow rate, which can be achieved by adjusting the FPW device output. Such a resulting micro-rheometer apparatus can be configured with a pole arrangement or it can be provided as a pole-less configuration. In general, shear stress is a function of viscosity and delta. One way to change involves switching between one FPW IDT and two FPW IDTs. When one IDT of the FPW device is “on”, the delta r is larger; when two IDTs are “on”, the flow changes and the delta r is smaller.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a rheometer apparatus, which can be implemented in accordance with one embodiment;

FIG. 2 illustrates a top view of a micro-rheometer apparatus, which can be implemented in accordance with an embodiment;

FIG. 3(a) illustrates a side view of a micro-rheometer apparatus, which can be implemented in accordance with an embodiment;

FIG. 3(b) illustrates a side view of a micro-rheometer apparatus, which can be implemented in accordance with another embodiment;

FIG. 4 illustrates a top view of a micro-rheometer apparatus, which can be implemented in accordance with a preferred embodiment;

FIG. 5 illustrates a side view of the micro-rheometer apparatus depicted in FIG. 4, in accordance with a preferred embodiment; and

FIG. 6 illustrates a block diagram depicting shear stress, shear rate and viscosity information associated with the configurations described herein in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In general, the method and system of measuring viscosity described herein can be implemented to employ a shear acoustic wave resonator in contact with a liquid. The viscosity of the liquid determines how thick a layer of fluid is hydro-dynamically coupled to the surface. The loading of the acoustic resonator caused by this viscously-entrained liquid is determined by the thickness and density of the entrained film. The response of an acoustic viscometer is thus proportional to the product of the viscosity, the density and the radian frequency of the vibration in the limit of low frequencies.

The acoustic wave resonator supports a standing wave through its thickness. The wave pattern interacts with electrodes on a lower surface (hermetically sealed from the liquid) and interacts with the fluid on an upper surface thereof. The bulk of the liquid is unaffected by the acoustic signal and a thin layer (of the order of microns or micro-inches) is moved by the vibrating surface (the vibration amplitudes are of the order of a single atomic spacing).

In general, rheology is the science of flow and deformation of materials. The viscosity of a material is related to its resistance to flow while the elasticity is related to its degree of structure. To determine the consistency of a material both its viscosity and elasticity parameters must be studied. The rheological properties of a material are determined by the temperature, the pressure and the strain or the shear rate. Knowing the magnitude of these parameters in industrial processes the viscous and the elastic properties of a material can be studied in a laboratory environment by using fundamental rheological instruments such as rheometers.

The measurement results can be used to study different material properties such as storage stability, consistency, melting temperature, hardening temperature, shear stability and molecular weight. It can also be used to optimize product quality and to predict the impact of an industrial process on a specific product formulation.

The most important concepts of rheology are defined as: shear stress, shear rate, strain, viscosity, elasticity and extensional viscosity. Parameters influencing the magnitude of these concepts will also be introduced. The viscosity of some known liquids is given as well as the shear rate of different industrial processes. The flow behavior of different liquids is presented: Time Independent liquids, such as Newtonian, shear thinning, shear thickening and yield stress and Time Dependent liquids, such as thixotropic, rheopectic and anti-thixotropic.

The flow behaviors can be presented utilizing varying linear and logarithmic viscosity and flow diagrams. Rheometry, that is the practical application of rheology, is therefore discussed herein in relation to the different flow behaviors. For instance, different measurement techniques must be applied to differentiate between shear thinning and thixotropic flow behavior. Measurement data are fitted to different flow models such as the Power Law, Bingham, Herschel Bulkley and the Casson to simplify the presentation of rheological measurement data over a wide shear rate range.

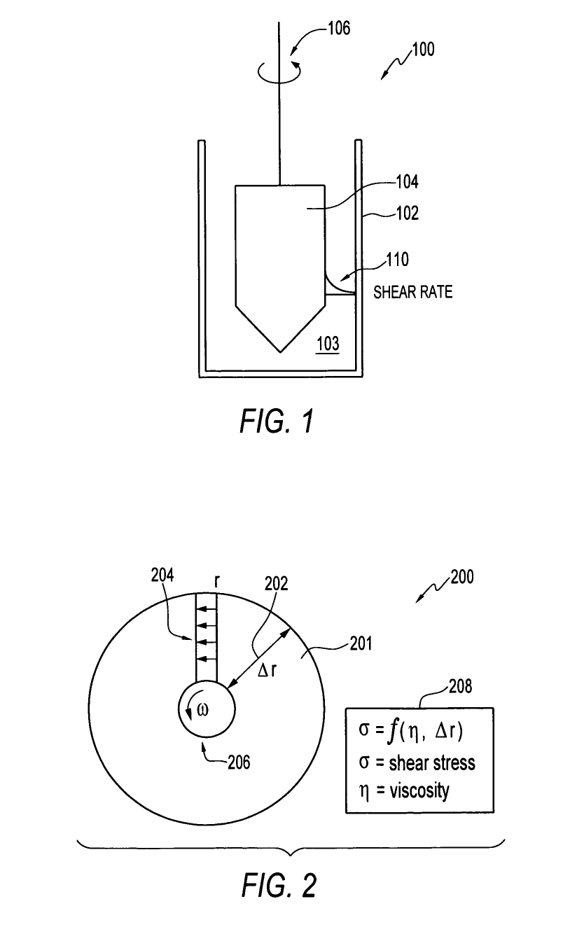

FIG. 1 illustrates a rheometer apparatus 100, which can be implemented in accordance with one embodiment. The rheometer apparatus 100 includes a housing and a flexural plate wave (FPW) device 104. Shear rate associated with FPW device 104 can be detected, as indicated by shear rate 110 depicted in FIG. 1. The rotational rate associated with the rheometer apparatus 100 is indicated by arrow 106 in FIG. 1. The rheometer apparatus 100 is based on the application of a rotational speed to a measuring system. A gap 103 is surrounded by housing 102. In the gap 103 in the measuring apparatus 100, the shear rate 110 can be defined. Shear rate 110 is a sample parameter, whereas the rotational speed represented by arrow 106 is an instrument parameter.

One non-limiting example of a FPW apparatus or device, which can be adapted for use in implementing FPW device 104, 204, and/or 404 is disclosed in U.S. Pat. No. 6,777,727, entitled “Flexural Plate Wave Systems,” which issued to Dunn, et al. on Aug. 17, 2004. U.S. Pat. No. 6,777,727 is incorporated herein by reference. Another non-limiting example of a FPW apparatus or device, which can be adapted for use in implementing FPW device 104, 204, and/or 404 is disclosed in U.S. Pat. No. 6,247,905, entitled “Method and Apparatus for Actively Controlling a Micro-Scale Flexural Plate Wave Device,” which issued to Jeffrey Dohner on Jun. 19, 2001. U.S. Pat. No. 6,247,905 is also incorporated herein by reference. A further non-limiting example of a FPW apparatus device, which can be adapted for use in implementing FPW device 104, 204, and/or 404, is disclosed in U.S. Pat. No. 5,836,203, entitled “Magnetically excited Flexural Plate Wave Apparatus,” which issued to Martin et al. on Nov. 17, 1998. U.S. Pat. No. 5,836,203 is also incorporated herein by reference. Such devices can be utilized for pumping fluids and/or gases, depending upon design considerations.

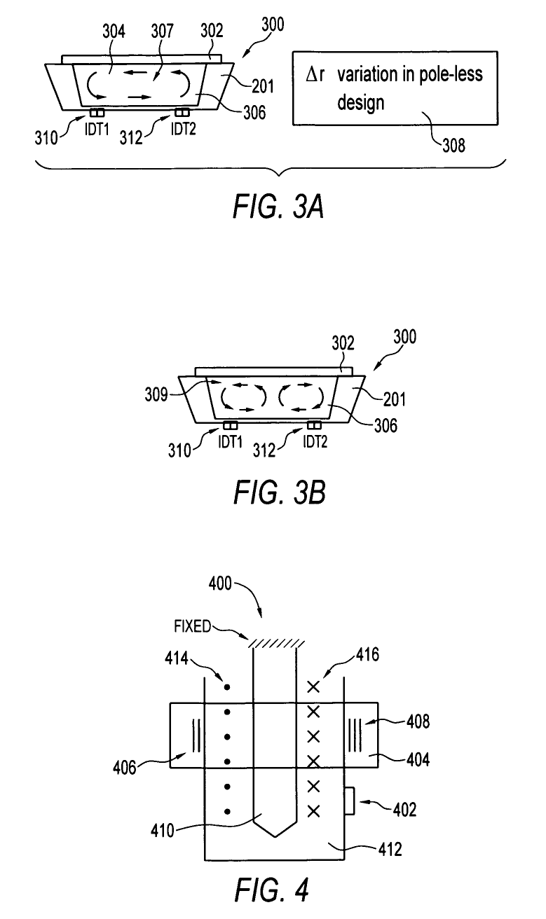

FIG. 2 illustrates a top view of a micro-rheometer apparatus 200, which can be implemented in accordance with an embodiment. The micro-rheometer apparatus 200 generally a central portion 206 located within a housing 201. Rotational rate 204 is indicated by with respect to the central portion 206, while the distance or radius 202 between the central portion 206 and the edge of housing 201 is also depicted in FIG. 2. Parameters associated with the micro-rheometer apparatus 200 are depicted in block 208. In the configuration depicted in FIG. 2, shear stress is a function of viscosity and Δr. One technique for changing Δr is depicted in FIGS. 3(a) and 3(b) with respect to the use of interdigital transducers 310, 312.

FIG. 3(a) illustrates a side view of a micro-rheometer apparatus 300, which can be implemented in accordance with an embodiment. FIG. 3(b) illustrates a side view of a micro-rheometer apparatus, which can be implemented in accordance with another embodiment 300. Note that in FIGS. 2-3, identical or similar parts or elements are generally indicated by identical reference numerals. The micro-rheometer apparatus 300 includes the use of interdigital transducers 310, 312, which are integrated with the housing 201, which can also constitute a flexural plate wave device.

The interdigital transducers 310, 312 can be disposed on a substrate integrated with said flexural plate wave device. Such a substrate may be, for example, a quartz (SiO₂) substrate, a lithium tantalate (LiTaO₃) substrate, a langasite (LGS) substrate, a lithium niobate (LiNbO₃) substrate, or a gallium phosphate substrate, depending on design considerations. Additionally, acoustic wave viscosity sensor and said flexural plate wave device described herein can include the use of a thin film piezoelectric layer that may be formed from materials such as, but not limited to ZnO, GaN, AlN, GaAs, SiC, PZT, and/or PVDF.

In general, the configuration depicted in FIGS. 3(a) and 3(b) describes an acoustic wave viscosity sensor based on the use of the flexural plate wave device configured to include a central cavity through which a fluid flows. A plurality of interdigital transducers 310, 312 are associated with said flexural plate wave device, such that the said plurality of interdigital transducers 310, 312 measures viscosity associated with said fluid over a variable range of shear rates, wherein said variable range of shear rates is achieved by varying a flow rate of said fluid due to an adjustment of a vibrating amplitude associated with said flexural plate wave device. Such an acoustic wave viscosity sensor can be provided in the context of an acoustic plate mode sensor device (APM), a shear-horizontal surface acoustic wave sensor device (SH-SAW), and/or a bulk acoustic wave sensor device (BAW), depending upon design considerations.

The acoustic wave viscosity sensor can be also be provided, for example, in the context of a love wave sensor device, a surface transverse wave sensor device (STW), a shear-horizontal acoustic plate mode sensor device (SH-APM), a quartz crystal micro-balance (QCM) or a thickness-shear mode (TSM) sensor device, a flexural plate wave (FPW), surface-skimming bulk wave (SSBW), and/or a Lamb wave sensor device, again depending upon design considerations.

As indicated above, one method for altering the Δr is to switch between one FPW interdigital transducer 310 and 312 or another interdigital transducer thereof. When one interdigital transducer 310 or 312 is “on”, the Δr is larger. When two interdigital transducers are “on” the flow changes and the Δr is smaller. In FIG. 3(a), rotation is generally indicated by arrows 307, while in FIG. 3(b), rotation is indicated by arrows 309. A section of micro-rheometer apparatus 300 is also depicted in FIGS. 3(a)-3(b) located above a central portion 306. Note that in FIGS. 3(a)-3(b), block 308 indicates that Δr variations exist in a “pole-less” design. FIGS. 3(a)-3(b) generally depicted such a “pole-less” configuration.

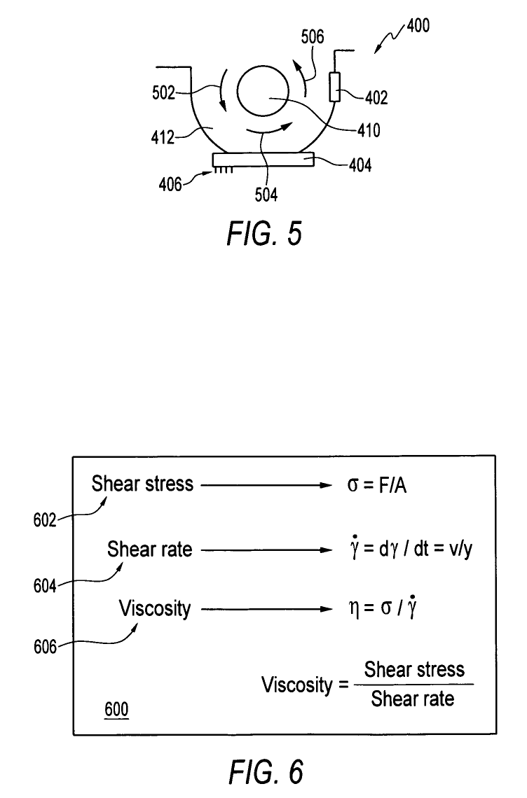

FIG. 4 illustrates a top view of a micro-rheometer apparatus 400, which can be implemented in accordance with a preferred embodiment. FIG. 5 illustrates a side view of the micro-rheometer apparatus 400 depicted in FIG. 4, in accordance with a preferred embodiment. Note that in FIGS. 4-5, identical or similar parts or elements are generally indicated by identical reference numerals. The micro-rheometer apparatus 400 depicted in FIGS. 4-5 generally includes an FPW device 408 configured perpendicular to a housing 412. The FPW device 408 is configured to incorporate the use of one or more interdigital transducers 406, 408. A shear rate measurement device 402 can be connected to housing 412. The housing 412 generally surrounds a central core 410 through which fluid can flow. Liquid flow directions 414 and 416 are indicated in FIG. 4. Note that central core 410 can be fixed to a mounting, depending upon design considerations. In FIG. 5, the flow direction associated with the flow of fluid is generally indicated by arrows 502, 504, 506.

FIG. 6 illustrates a block diagram 600 depicting shear stress 602, shear rate 604 and viscosity information 606, 608 associated with the configurations described herein in accordance with a preferred embodiment.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A rheometer apparatus, comprising:
an acoustic wave viscosity sensor associated with a flexural plate wave device configured to include a central cavity through which a fluid flows; and
a plurality of interdigital transducers associated with said flexural plate wave device, wherein said plurality of interdigital transducers measures viscosity associated with said fluid over a variable range of shear rates, wherein said variable range of shear rates is achieved by varying a flow rate of said fluid due to an adjustment of a vibrating amplitude associated with said flexural plate wave device.

2. The apparatus of claim 1 wherein said rheometer further comprises a shear rate measurement sensor connected to said flexural plate wave device, wherein said shear rate measurement sensor comprises at least on interdigital transducer for detecting acoustic wave viscosity data associated with a flow of said fluid through said central cavity of said flexural plate wave device.

3. The apparatus of claim 1 wherein said central cavity comprises a tube through which said fluid flows.

4. The apparatus of claim 1 wherein said plurality of interdigital transducers are disposed on a substrate Integrated with said flexural plate wave device.

5. The apparatus of claim 1 wherein said acoustic wave viscosity sensor comprises an acoustic plate mode sensor device (APM).

6. The apparatus of claim 3 wherein said central cavity is disposed within a housing.

7. The apparatus of claim 3 wherein said plurality of interdigital transducers is integrated with said housing.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A rheometer apparatus, comprising:
an acoustic wave viscosity sensor associated with a flexural plate wave device configured to include a central cavity through which a fluid flows;
a plurality of Interdigital transducers associated with said flexural plate wave device, wherein said plurality of interdigital transducers measures viscosity associated with said fluid over a variable range of shear rates, wherein said variable range of shear rates is achieved by varying a flow rate of said fluid due to an adjustment of a vibrating amplitude associated with said flexural plate wave device; and
a shear rate measurement sensor connected to said flexural plate wave device, wherein said shear rate measurement sensor comprises at least on interdigital transducer for detecting acoustic wave viscosity data associated with a flow of said fluid through said central cavity of said flexural plate wave device.
